(19) United States
(12) Patent Application Publication
(10) Pub. No.: US 2003/0048254 A1
(43) Pub. Date: Mar. 13, 2003

(54) Wireless peripherals charged by electromagnetic induction

(76) Inventor: Shih-Sheng Huang, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,357

(22) Filed: Jul. 4, 2002

(30) Foreign Application Priority Data
Sep. 7, 2001 (TW) 090122197

(51) Int. Cl. G09G 5/08

(52) U.S. Cl. 345/163; 345/158

(57) ABSTRACT

A wireless pointing device can be charged by an induction power device. The induction power device includes a base with a plate and a first induction coil for converting electrical power of a power source to an induction magnetic field. The wireless pointing device has a housing with a contact plane corresponding to the plate, a second induction coil installed in the housing for receiving the induction magnetic field through the contact plane, a power module for transforming the induction field received by the second induction coil to a corresponding electrical power, and a storage module for storing the electrical power generated by the power module. When the wireless pointing device is put on the plate of the induction power device, the second induction coil receives the induction magnetic field generated by the first induction coil such that the wireless pointing device can be charged by the induction power device.

### BACKGROUND OF INVENTION

1. Field of the Invention

The present invention relates to a wireless peripheral, and more particularly, to a wireless peripheral charged by electromagnetic induction.

2. Description of the Prior Art

As information systems of mobile phones, PDAs (personal digital assistants), and computers develop day-by-day, the peripherals of these information systems are improved as well. The peripherals provide a convenient human-machine interface, and increase efficiency when users use information systems to access data and accumulate knowledge. Users enjoy using wireless peripherals since the wireless peripherals are not restricted by a wire. For example, when using a wireless mouse, a wire does not interfere with the user's ability to operate the computer. Likewise, the wireless earphones used in mobile phones or communication systems also do not require a transmission wire. This is especially important when driving a car. The transmission wire of traditional earphones interferes with the ability of a driver to drive, and is not safe. However, the wireless earphone does not have this defect.

Although the wireless peripherals have so many advantages, the wireless peripherals still need power-storage devices such as batteries to provide electrical power to the wireless peripherals. When the electrical power of batteries or power-storage devices is depleted, users must exchange the battery or charge the power-storage device. It is an inconvenience that users must keep many batteries on hand to re-supply electrical power to the wireless peripherals in time.

In prior art technology, the charging device of the wireless peripherals has a power transmission port, and the peripherals have a corresponding charging port. When users want to charge the peripherals, users must insert the power transmission port of the charging device into the charging port of the wireless peripheral. This is inconvenient because users must insert the power transmission port of the charging device into the charging port often so as to keep the wireless peripherals charged.

### SUMMARY OF INVENTION

It is therefore a primary objective of the claimed invention to provide a wireless peripheral, which charged by electromagnetic induction, so as to solve the problem of the prior art technology.

The claimed invention, briefly summarized, discloses a wireless pointing device for a computer and related wireless peripherals. The wireless pointing device can be charged by an induction power device. The induction power device includes a base with a plate and a first induction coil installed corresponding to a position of the plate for converting an electrical power of a power source to an induction magnetic field. The wireless pointing device has a housing with a contact plane corresponding to the plate, at least a key installed on the housing for generating a control signal corresponding to a user's control, a signal module for transmitting the control signal in radio waves, a second induction coil installed in the housing for receiving the induction magnetic field through the contact plane, a power module for transforming the induction field received by the second induction coil to a corresponding electrical power, and a storage module for storing the electrical power generated by the power module. When the wireless pointing device is put on the plate of the induction power device, the second induction coil receives the induction magnetic field generated by the first induction coil such that the wireless pointing device can be charged by the induction power device.

It is an advantage of the claimed invention that the claimed invention uses the induction magnetic field to transmit the electrical power. Users only need to put the wireless peripheral on the induction power device so that the wireless peripheral can be charged. The claimed invention can increase the efficiency and duration of use of the wireless peripheral.

These and other objectives of the claimed invention will no doubt become obvious to those of ordinary skill in the art after reading the following detailed description of the preferred embodiment which is illustrated in the various figures and drawings.

### BRIEF DESCRIPTION OF DRAWINGS

FIG. 1 is a perspective view of a wireless mouse according to the first embodiment of the present invention.

FIG. 2 is a structural diagram of the wireless mouse shown in FIG. 1.

FIG. 3 is a perspective view of another embodiment of the present invention, in which a wireless earphone is charged by an induction power device.

FIG. 4 is a structural diagram of the present invention wireless earphone and the induction power device.

### DETAILED DESCRIPTION

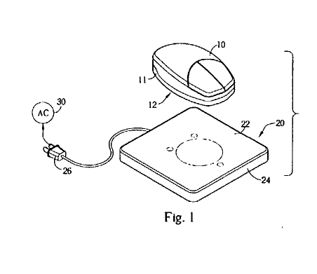

Please refer to FIG. 1. FIG. 1 is a perspective view of a wireless mouse 10 according to the first embodiment of the present invention. The present invention wireless mouse 10 acts as a wireless pointing device that can be charged by an induction power device 20 in an electromagnetic induction manner. The induction power device 20 comprises a base 24. An upper surface of the base 24 contains a flat-plate 22. A lower surface of a housing 11 of the wireless mouse 10 comprises a contact plane 12 corresponding to the flat-plate 22. Power of a power source 30 (the present embodiment uses an alternating current power source provided by a family socket as an example, however, the present invention can also use other power sources) inputs into the induction power device 20 through a plug 26. The induction power device 20 transforms the power of the power source 30 into an induction magnetic field, and then transmits out the induction magnetic field through the flat-plate 22. When the wireless mouse 10 is put on the flat-plate 22, the induction magnetic field emitted from the induction power device 20 passes through the flat-plate 22 and the contact plane 12 of the wireless mouse 10, and is then received by the wireless mouse 10. The wireless mouse 10 receives the induction magnetic field and transforms the induction magnetic field into electrical power so that the wireless mouse 10 is charged.

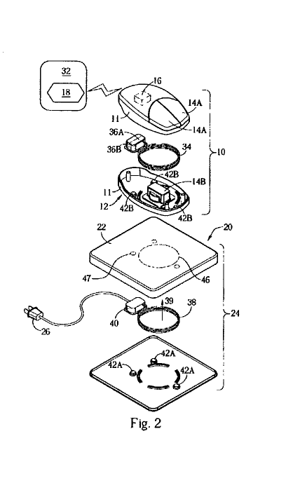

Please refer to FIG. 2 for a further illustration of the structure and the operating principle of the present invention wireless mouse 10. FIG. 2 is a structural diagram of the wireless mouse shown in FIG. 1. The wireless mouse 10 comprises control keys 14A installed on the housing 11 of the wireless mouse 12 for generating a control signal corresponding to a user's control. A position detector 14B (can be a rolling ball position detector or an optical position detector) is installed inside the wireless mouse 12 for detecting movement of the wireless mouse 10 and generating a corresponding pointing signal. The control signal and the pointing signal are transmitted into a signal module 16. Then the signal module 16 transmits out the control signal and the pointing signal through radio waves. A receiving module 18 of a computer 32 receives the radio control signal and pointing signal, and then performs a corresponding operation (such as choosing an item on a user interface of the computer 32, or moving a pointer on the user interface). Therefore, users can control the computer 32 by using the wireless mouse.

The induction power device 20 for charging the wireless mouse 10 comprises a power transforming system 40 and a first induction coil 38. The power transforming system 40 is electrically connected to the power plug 26. When the power of the power source 30 is inputted into the power transforming system 40 through the power plug 26, then the power transforming system 40 transforms the power to a suitable alternating current power, and the alternating current power is driven to flow into the first induction coil 38. The alternating current power flowing inside the first induction coil 38 generates an induction magnetic field along an arrow 39 orientation, and the induction magnetic field goes through the flat-plate 22.

The wireless mouse 10 includes a second induction coil 34 corresponding to the first induction coil 38 of the induction power device 20. The second induction coil 34 is electrically connected to a power module 36A, and the power module 36A is electrically connected to a storage module 36B. When the second induction coil 34 receives the induction magnetic field generated by the first induction coil 38 through the flat-plate 22 and the contact plane 12, a corresponding induction current is generated inside the second induction coil 34. The power module 36A transforms the alternating current power of the induction current into a direct current power (it can be achieved by a standard alternating current to direct current commutation circuit). The storage module 36B stores the transformed direct current so that the wireless mouse 10 is charged.

In order to transmit the magnetic power between the first induction coil 38 and the second induction coil 34 efficiently, the position of the first induction coil 38 must align with the position of the second induction coil 34. That means a center of the first induction coil 38 must coincide with a center of the second induction coil 34, so that an overlap projection area of the first induction coil 38 and the second induction coil 34 is at a maximum. A dashed line 46 shown in FIG. 2 is a projection of the first induction coil 38 on the flat-plate 22. If the projection of the second induction coil 34 on the flat-plate 22 can align with the dashed line 46 (the overlap area is at a maximum) when the wireless mouse 10 is put on the flat-plate 22, the induction power device 20 can most efficiently charge the wireless mouse 10. In order to achieve this purpose, the present invention induction power device 20 comprises first magnets 42A acting as first fixers. The wireless mouse 10 also comprises second magnets 42B acting as second fixers corresponding to the position of the first magnet 42A. When the first magnets 42A and the second magnets 42B mutually attract, the wireless mouse 10 can be fixed on the flat-plate 22 in a fixed position. This fixed position causes the first induction coil 38 to exactly align with the second induction coil 34 so that the magnetic power can be most efficiently transmitted. Thus, users do not need to specially put the wireless mouse 10 on the fixed position of the flat-plate 22. Users only need to put the wireless mouse 10 somewhere on the flat-plate, then the first magnets 42A in the induction power device 20 and the second magnets 42B in the wireless mouse 10 will mutually attract so that the wireless mouse 10 is fixed in the optimum position. Therefore, the magnetic power can be transmitted in the most efficient manner. Dashed lines 47 marked on the flat-plate 22 shown in FIG. 2 are projection positions of the first magnets 42A of the induction power device 20. When a projection position of the second magnets 42B of the wireless mouse 10 overlaps the position of the dashed line 47, then the projection position of the first induction coil 38 aligns with the projection position of the second induction coil 34.

In the present invention embodiment described above, users only need to put the wireless mouse 10 on the flat-plate 22 when users stop using the wireless mouse 10 (such as taking a break), then the induction power device 20 charges the wireless mouse 10 by electromagnetic induction. If users use the wireless mouse 10 again, they only need to take the wireless mouse from the flat-plate, but need not pull out the power transmission port from the charging port as was the case with the prior art. Therefore, the present invention is more convenient than the prior art, and the invention can keep the electrical power of the wireless mouse 10 charged at all times.

Another embodiment of the present invention wireless mouse 10 is that a radius of the first induction coil 38 is larger than a radius of the second induction coil 34. The first induction coil 38 has a wider projection area than the second induction coil 34. Therefore, users can use the flat-plate 22 as a mouse pad, and move the wireless mouse 10 on the flat-plate 22 to control the user interface directly. Since the first induction coil 38 has wider area than the second induction coil 34, the second induction coil 34 in the wireless mouse 10 is easily kept inside the projection area of the first induction coil 38, even if users are moving the wireless mouse 10. Therefore, the second induction coil 34 can receive the induction magnetic field generated by the first induction coil 38 efficiently. The wireless mouse 10 can be charged by the induction magnetic field all the time. Whether users are moving the wireless mouse 10 or not moving the wireless mouse 10, the wireless mouse 10 also can be charged by electromagnetic induction.

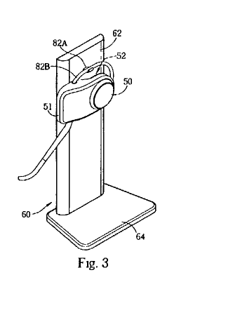

Please refer to FIG. 3. FIG. 3 is a perspective view of another embodiment of the present invention in which a wireless earphone 50 is charged by an induction power device 60. The wireless earphone 50 can be a wireless earphone using the bluetooth wireless transmission standard. The wireless earphone 50, covered by a housing 51, includes a hanging arm 82B. Users can hang the hanging arm 82B on their ears when using the wireless earphone 50, so as to fix the position of the wireless earphone 50. The present invention comprises the induction power device 60 for charging the wireless earphone 50. The induction power device 60 includes a base 24 and a flat-plate 62. A hook 82A is installed on the flat-plate 62. Users can hang the hanging arm 82B of the wireless earphone 50 on the hook 82A of the induction power device 60 when users stop using the wireless earphone 50. At this time, a contact plane 52 of the wireless earphone 50 aligns with the flat-plate 62 exactly, as shown in FIG. 3. As explained in the first embodiment, the induction power device 60 transforms the electrical power into the induction magnetic field. The wireless earphone 50 receives the induction magnetic field, and transforms the induction magnetic field into electrical power so as to charge the wireless earphone 50.

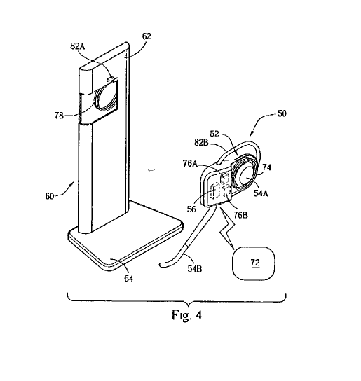

Please refer to FIG. 4. FIG. 4 is a structural diagram of the present invention wireless earphone 50 and the induction power device 60. In order to make the drawing clearer, a portion of the housing of the induction power device 60 and the wireless earphone 50 are omitted in FIG. 4. The wireless earphone 50 is used for a broadcast system 72 that can emit a radio broadcast signal. The broadcast system 72 can be a mobile phone, a computer, or a general radio. A signal module 56 inside the wireless earphone 50 can receive the broadcast signal, and transforms the broadcast signal into a corresponding sound signal. The sound signal is transmitted to a loudspeaker 54A in the wireless earphone 50. The loudspeaker 54A transforms the sound signal into sound (or music) so that users can listen to the sound (or music). Furthermore, a microphone 54B of the wireless earphone 50 can receive speech sound of users, and transform the speech sound into a corresponding sound signal. The sound signal is transmitted to the signal module 56, and then the signal module 56 transmits the sound signal to the broadcast system 72 through radio signals.

Similar to the first embodiment of the present invention, in order to charge the wireless earphone 50, the induction power device 60 includes a first induction coil 78 for transforming a power source (not shown) into an induction magnetic field. The wireless earphone 50 includes a second induction coil 74 corresponding to the first induction coil 78. The second induction coil 74 receives the induction magnetic field generated by the induction power device 60. A power module 76A installed in the wireless earphone 50 transforms an alternating current power of the induction magnetic field into a direct current power. The power module 76A transmits the direct current power into a storage module 76B so that the storage module 76B can provide electrical power to the wireless earphone 50, and for achieving the purpose of charging the wireless earphone 50 with induction magnetic field.

As mentioned above, when the first induction coil 78 aligns with the second induction coil 74, the induction magnetic field can be transmitted with the most efficiency. The hook 82A acts as a first fixer. The hanging arm 82B on the wireless earphone 50 acts as a second fixer. When the hanging arm 82B of the wireless earphone 50 is hung on the hook 82A, then the first induction coil 78 aligns with the second induction coil 74. Of course, the wireless earphone 50 can use the magnets to be the fixers so as to align the first induction coil 78 with the second induction coil 74. The induction magnetic field can be transmitted with the most efficiency. As with the first embodiment, users can charge the wireless earphone 50 without inserting a power transmission port into a charging port of the wireless earphone 50.

In the prior art, users must prepare several batteries, or insert the power transmission port into the charging port of the wireless peripheral, so as to maintain electrical power of the wireless peripheral. However, the present invention uses the induction magnetic field to transmit the electrical power. Therefore, the present invention does not require a lot of batteries, or insertion of the power transmission port into the charging port of the wireless peripheral. The fixers of the present invention automatically guide the wireless peripherals position on the optimum position of the induction power device. The induction magnetic field can be transmitted with the highest efficiency. When users use the present invention wireless peripheral, even during just a short break, users also can put the wireless peripheral on the induction power device so as to charge the wireless peripheral.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A wireless pointing device for a computer, the wireless pointing device capable of being charged by an induction power device, the induction power device comprising:
a base with a flat-plate; and
a first induction coil installed corresponding to a position of the flat-plate for transforming an electrical power of a power source to an induction magnetic field; and
the wireless pointing device comprising:
a housing with a contact plane corresponding to the flat-plate;
at least a control key installed on the housing for generating a control signal corresponding to a user's control;
a signal module electrically connected to the control key for transmitting the control signal through radio waves;
a second induction coil installed inside the housing corresponding to a position of the contact plane for receiving the induction magnetic field through the contact plane in a magnetic induction manner;
a power module electrically connected to the second induction coil for transforming the induction magnetic field received by the second induction coil to a corresponding electrical power; and
a storage module for storing the electrical power generated by the power module so that the storage module is capable of providing the electrical power to the wireless pointing device;
wherein when the contact plane of the wireless pointing device is put on the flat-plate of the induction power device, the second induction coil of the wireless point device receives the induction magnetic field generated by the first induction coil so that the wireless pointing device is capable of being charged by the induction power device.

2. The wireless pointing device of claim 1 wherein at least a first fixer is installed in the induction power device corresponding to the position of the flat-plate, and at least a second fixer is installed on the contact plane corresponding to the first fixer, and when the contact plane of the wireless pointing device is put on the flat-plate of the induction power device, the first fixer brakes the second fixer so as to fix the position of the wireless pointing device and make the position of the first induction coil align with the position of the second induction coil.

3. The wireless pointing device of claim 2 wherein the first fixer is a magnet.

4. The wireless pointing device of claim 2 wherein the second fixer is a magnet.

5. The wireless pointing device of claim 1 being a wireless mouse.

6. The wireless pointing device of claim 1 wherein the computer comprises a receiving module for receiving the radio control signal transmitted from the wireless pointing device.

7. A wireless earphone for a broadcast system, the broadcast system emitting a radio broadcast signal, the wireless earphone capable of being charged by an induction power device, the induction power device comprising:
a base with a flat-plate; and
a first induction coil installed corresponding to a position of the flat-plate for transforming an electrical power of a power source to an induction magnetic field;
the wireless earphone comprising:
a housing with a contact plane corresponding to the flat-plate;
a signal module for receiving the radio broadcast signal of the broadcast system and generating corresponding music signal;
a loudspeaker electrically connected to the signal module for playing the music signal;
a second induction coil installed inside the housing corresponding to a position of the contact plane for receiving the induction magnetic field through the contact plane in a magnetic induction manner;
a power module electrically connected to the second induction coil for transforming the induction magnetic field received by the second induction coil to a corresponding electrical power; and
a storage module for storing the electrical power generated by the power module so that the storage module is capable of providing the electrical power to the wireless earphone;
wherein when the contact plane of the wireless earphone is put on the flat-plate of the induction power device, the second induction coil of the wireless earphone receives the induction magnetic field generated by the first induction coil so that the wireless earphone is capable of being charged by the induction power device.

8. The wireless earphone of claim 7 wherein at least a first fixer is installed on the flat-plate, and at least a second fixer is installed on the contact plane corresponding to the first fixer, when the contact plane of the wireless is put on the flat-plate of the induction power device, the first fixer brakes the second fixer so as to fix the position of the wireless earphone and make the position of the first induction coil align with the position of the second induction coil.

9. The wireless earphone of claim 7 wherein the first fixer is a magnet.

10. The wireless earphone of claim 7 wherein the first fixer is a hook.

11. The wireless earphone of claim 7 further comprising a microphone for receiving speech sound of users and generating a corresponding sound signal.

12. The wireless earphone of claim 11 wherein the signal module is capable of transmitting the sound signal through radio waves, and the broadcast system is capable of receiving the radio sound signal.

13. The wireless earphone of claim 7 being a bluetooth wireless earphone.
